(19) United States
(12) Patent Application Publication
(10) Pub. No.: US 2014/0169326 A1
(43) Pub. Date: Jun. 19, 2014

(54) Synchronization

(71) Applicant: Broadcom Corporation, Irvine, CA (US)

(72) Inventors: Toni LEVANEN, Tampere (FI); Jukka TALVITIE, Tampere (FI); Timo KOSKELA, Oulu (FI)

(73) Assignee: Broadcom Corporation, Irvine, CA (US)

(21) Appl. No.: 14/132,283

(22) Filed: Dec. 18, 2013

(30) Foreign Application Priority Data
Dec. 19, 2012 (GB) 1222970.4

(51) Int. Cl. H04W 56/00; H04L 5/00

(52) U.S. Cl. CPC H04W 56/0015; H04W 56/001; H04L 5/0007
USPC 370/330; 370/328

(57) ABSTRACT

Measures for synchronization and channel estimation in local area communication scenarios. Such measures may for example comprise generating a synchronization reference sequence for synchronization of two communication endpoints and for estimation of characteristics of a communication channel, determining a maximum repetition interval of the synchronization reference sequence based on constancy of the characteristics of the communication channel, and transmitting the synchronization reference sequence with a repetition interval equal to or less than the maximum repetition interval.

### TECHNICAL FIELD

The present invention relates to synchronization and channel estimation. In particular, but not exclusively, the present invention relates to measures (including methods, apparatuses and computer program products) for realizing synchronization and channel estimation in local area communication scenarios.

### BACKGROUND

The present specification generally relates to communication in wireless local areas communication scenarios.

In wireless communications, in order to allow data transmission between transmitter and receiver, the receiver has to synchronize itself to the frame and symbol timing and carrier frequency used by the transmitter. Depending on the deployment scenario, a sufficient set of synchronization signaling is added to the transmitted sequence to facilitate the receiver to perform time and frequency synchronization in the beginning of communications. All this signaling is undesired overhead in the transmission and does not provide any additional value for the end user in view of payload to be transmitted/received.

In addition to synchronization signaling, typically, separate reference symbols (RS) are required for channel estimation. Depending on the deployment scenario, a sufficient time and frequency resolution is required from the transmitted RS in order to correctly estimate channel in time and frequency domain, and also to track frequency and timing estimates to keep the system synchronized.

For local area communication scenarios, it is assumed that a system according to the present application is synchronized and that an orthogonal frequency domain multiplexing (OFDM) symbol, a transmit time interval (TTI) duration, and a frame duration are very short compared to a channel coherence time. The channel coherence time depends on user mobility, which can be assumed to be low or relatively low in local area networks.

According to current local area related solutions for synchronization and channel estimation, a transmission of separated synchronization and channel estimation symbols is proposed and/or implemented, referred to as preamble in wireless local area network (WLAN) and Worldwide Interoperability for Microwave Access (WiMAX). Furthermore, additional pilot tones are added among the data subcarriers in WLAN and WiMAX standards.

Furthermore, when considering WiMAX or Long Term Evolution (LTE), the numerology thereof (i.e. technical specifications) is fitted for a macro cell environment and not optimized for local area communications. Therefore, the overhead of RS used for channel estimation and tracking in LTE and WiMAX is considered to be too large for local area communications because of the initial assumptions for cell size and mobility those techniques are originally intended for.

Hence, a problem arises that current solutions for synchronization and channel estimation do not properly consider the conditions of local area communication scenarios. Accordingly, when implementing those solutions, enormous undesired overhead is caused.

In particular, according to WLAN 802.11ac specification, each transmission starts with a common preamble which consists of legacy synchronization and training overhead, control signaling, and very high throughput (VHT) operation related synchronization and training overhead. This is also shown in FIG. 1, illustrating the preamble structure according to WLAN 802.11 ac specification. In addition, a certain number of pilot tones are multiplexed among the data subcarriers in the control and data portions to the transmitted packet. The legacy portion (diagonally hatched) of the preamble is used for initial frequency and timing synchronization, automatic gain control (AGC) setting, and channel estimation for legacy part control (in order to detect the legacy signal (L-SIG)). The VHT portion (vertically hatched) is used for improved frequency and timing synchronization and multiple input multiple output (MIMO) channel estimation for VHT portion of the packet (for detecting all channels between transmit-receive antenna pairs in order to detect VHT signals VHT-SIG A, VHT-SIG B and the data fields). Pilot tones (cross-hatched) are multiplexed among the transmitted data for channel estimation and synchronization tracking This is because the packet duration depends on the used modulation and coding scheme (MCS) and physical layer convergence protocol (PLCP) protocol data unit (PPDU) size, and since there can be significant changes in the channel during a long transmission.

The main drawback of a WLAN approach is the significant overhead caused by the preamble design with small data packets, and also with relatively large data packets when MIMO and high MCS are used. This is because the time duration of the preamble is fixed but the actual data portion can be very short in time with respect to the preamble.

Whereas in LTE, according to LTE specifications, LTE cell specific training signals are provided. These LTE cell specific training signals (a.k.a. reference symbols) are exemplarily illustrated for one (upper illustration) and two (lower illustration) antenna port configurations in FIG. 2.

As can be seen on FIG. 2, the reference symbols are repeated in the frequency domain every 6^{th} subcarrier and in the time domain for the respective subcarriers every slot (, i.e. every 7 OFDM symbols). Cell specific synchronization signals (primary synchronization sequence (PSS) and secondary synchronization sequence (SSS)) are repeated twice every 10 ms radio frame, hence once in the 5 ms half frame. The cell specific synchronization signals are not shown in FIG. 2.

The selected spacing in time between cell reference symbols was designed to support user equipment (UE) speeds up to 500 km/h and the selected spacing in the frequency domain was designed with respect to the expected macro propagation environment (large cells with radius' exceeding 1 km). These assumptions differ greatly from the assumptions used for local area environments and thus introduce unnecessary overhead. In the LTE case, the main loss in spectral efficiency in local area communications is because of the RS. The loss caused by the synchronization channel is relatively small, but could also be improved.

Further, the WiMAX system is designed for a macro environment. Thus it is designed with RS symbols multiplexed among downlink (DL) or uplink (UL) transmission causing significant RS overhead. The preamble as used in WiMAX is shown in FIG. 3, illustrating a frame structure according to WiMAX time division duplex (TDD) operation. This WiMAX preamble (diagonally hatched) works in a similar manner as in WLAN discussed earlier, and is used for cell identification, synchronization and channel estimation. According to the WiMAX design, the whole first OFDM symbol is dedicated for preamble.

Hence, it would be desirable to provide measures for realizing efficient synchronization and channel estimation in local area communication scenarios.

### SUMMARY

Various aspects of embodiments of the present invention are set out in the appended claims.

According to a first aspect of the present invention, there is provided a method for use in synchronization and channel estimation, the method comprising:

generating a synchronization reference sequence for synchronization of two communication endpoints and for estimation of characteristics of a communication channel;

determining a maximum repetition interval of the synchronization reference sequence based on constancy of the characteristics of the communication channel; and

transmitting the synchronization reference sequence with a repetition interval equal to or less than the maximum repetition interval.

According to a second aspect of the present invention, there is provided a method for use in synchronization and channel estimation, the method comprising:

receiving a synchronization reference sequence for synchronization of two communication endpoints and for estimation of characteristics of a communication channel;

synchronizing with a transmission corresponding to the synchronization reference sequence based on the synchronization reference sequence; and

estimating the characteristics of the communication channel based on the synchronization reference sequence.

According to a third aspect of the present invention, there is provided an apparatus for use in synchronization and channel estimation on a network side of a wireless system. The apparatus comprises a processing system that includes at least one processor and a memory storing computer program code, and the processing system is arranged to cause the apparatus to:

generate a synchronization reference sequence for synchronization of two communication endpoints and for estimation of characteristics of a communication channel;

determine a maximum repetition interval of the synchronization reference sequence based on constancy of the characteristics of the communication channel; and

transmit the synchronization reference sequence with a repetition interval equal to or less than the maximum repetition interval.

According to a fourth aspect of the present invention, there is provided an apparatus for use in synchronization and channel estimation on a terminal side of a wireless system The apparatus comprises a processing system that includes at least one processor and a memory storing computer program code, and the processing system is arranged to cause the apparatus to:

receive a synchronization reference sequence for synchronization of two communication endpoints and for estimation of characteristics of a communication channel;

synchronize with a transmission corresponding to the synchronization reference sequence based on the synchronization reference sequence; and

estimate the characteristics of the communication channel based on the synchronization reference sequence.

According to a fifth aspect of the present invention, there is provided a computer program product comprising computer-executable computer program code which, when executed on a computerised device (e.g. a computer of an apparatus according to any one of the aforementioned apparatus-related aspects of the present invention), is configured to cause the computerised device to carry out the method according to any one of the aforementioned method-related aspects of the present invention.

Such computer program product may comprise (or be embodied) a (tangible) computer-readable (storage) medium or the like on which the computer-executable computer program code is stored, and/or the program may be directly loadable into an internal memory of the computer or a processor thereof.

According to a sixth aspect of the present invention, there is provided a method substantially in accordance with any of the examples as described herein with reference to and illustrated by the accompanying drawings.

According to a seventh aspect of the present invention, there is provided apparatus substantially in accordance with any of the examples as described herein with reference to and illustrated by the accompanying drawings.

Any one of the above aspects enables at least an efficient synchronization and channel estimation in local area communication scenarios to thereby solve at least part of the problems and drawbacks identified in relation to the prior art.

By way of embodiments of the present invention, there is provided synchronization and channel estimation in local area communication scenarios. More specifically, by way of embodiments of the present invention, there are provided measures and mechanisms for realizing synchronization and channel estimation in local area communication scenarios.

Thus, improvement is achieved by methods, apparatuses and computer program products enabling/realizing synchronization and channel estimation in local area communication scenarios.

Further features and advantages of the invention will become apparent from the following description of preferred embodiments of the invention, given by way of example only, which is made with reference to the accompanying drawings.

### BRIEF DESCRIPTION OF THE DRAWINGS

In the following, the present invention will be described in greater detail by way of non-limiting examples with reference to the accompanying drawings, in which:

FIG. 1 is a schematic diagram illustrating preamble structure according to WLAN 802.11ac specification;

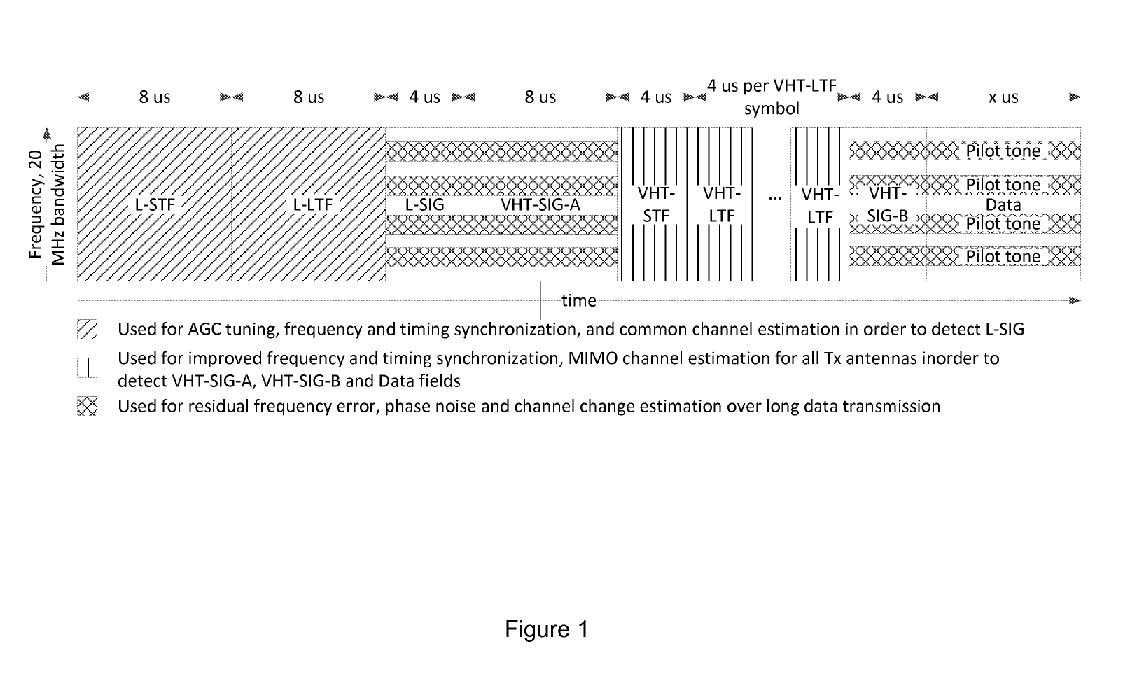

FIG. 2 is a schematic diagram illustrating example distribution of reference symbols in frequency and time domain for one (upper illustration) and two (lower illustration) antenna port configurations in LTE;

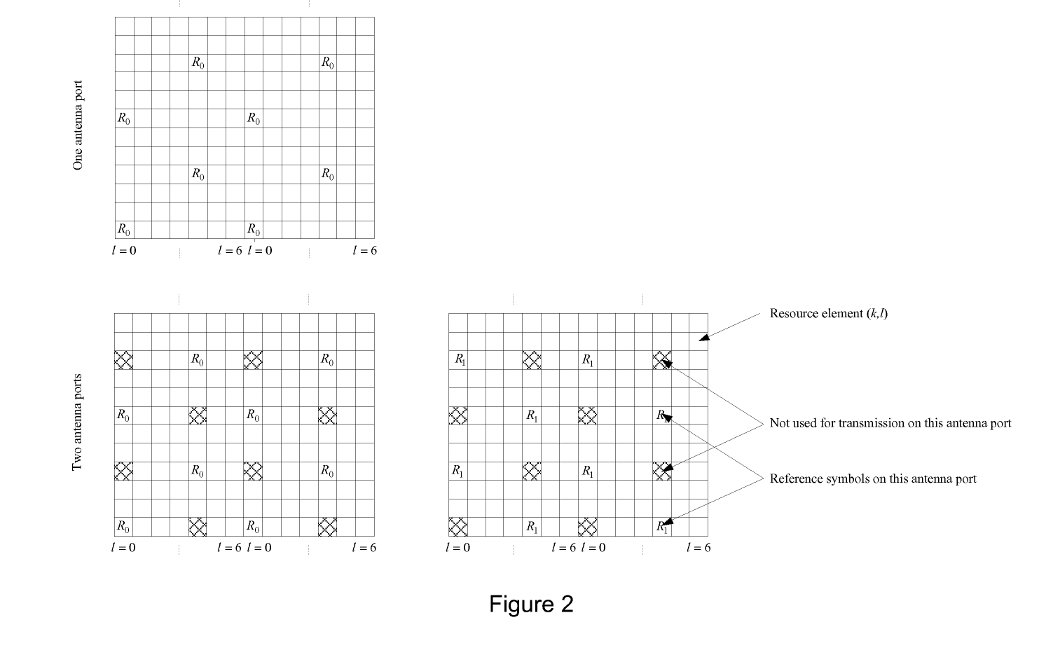

FIG. 3 is a schematic diagram illustrating preamble structure according to WiMAX design for TDD operation;

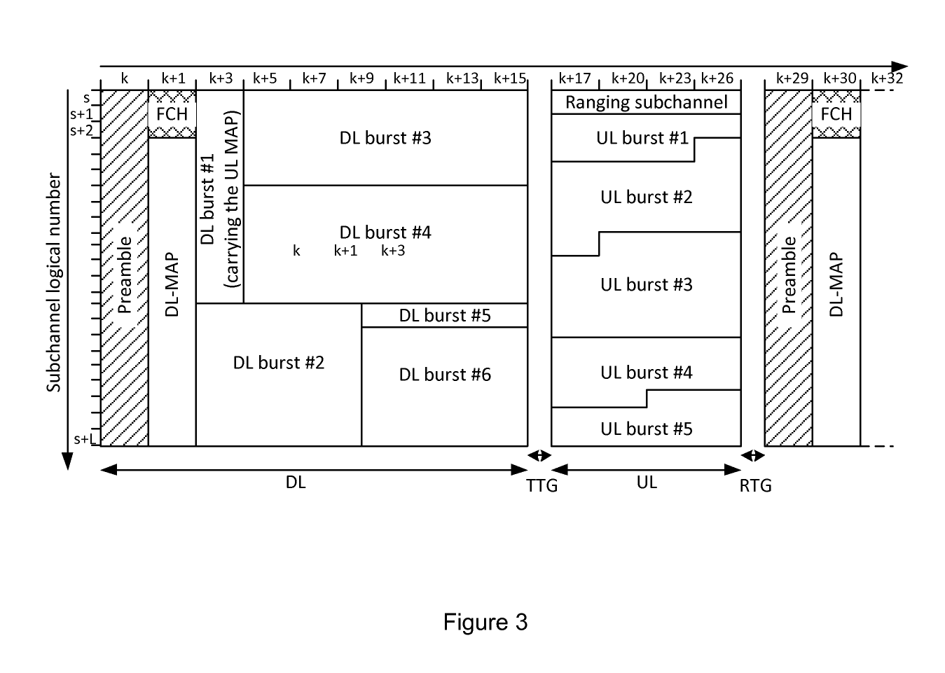

FIG. 4 is a schematic diagram illustrating a procedure according to embodiments of the present invention;

FIG. 5 is a schematic diagram illustrating a procedure according to embodiments of the present invention;

FIG. 6 is a schematic diagram illustrating example distribution of a synchronization reference sequences in frequency and time domain according to embodiments of the present invention;

FIG. 7 is a schematic diagram illustrating example distribution of a synchronization reference sequences in frequency and time domain according to embodiments of the present invention;

FIG. 8 is a schematic diagram illustrating a procedure to use frequency spread synchronization reference symbols in OFDM transmission according to embodiments of the present invention; and

FIG. 9 is a block diagram illustrating apparatuses according to embodiments of the present invention.

### DETAILED DESCRIPTION

The present invention is described herein with reference to particular non-limiting examples and embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain example network configurations and deployments. Namely, the present invention and its embodiments are mainly described in relation to 3^{rd} Generation Partnership Project (3GPP) specifications being used as non-limiting examples for certain example network configurations and deployments. As such, the description of embodiments given herein specifically refers to terminology which is directly related thereto. Such terminology is only used in the context of the presented non-limiting examples, and does naturally not limit the invention in any way. Rather, any other communication or communication related system deployment, etc. may also be utilized as long as compliant with the features described herein.

In particular, the present invention and its embodiments may be applicable in any network in which local area communication scenarios may occur.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to embodiments of the present invention, in general terms, there are provided measures and mechanisms for (enabling/realizing) synchronization and channel estimation in local area communication scenarios.

According to embodiments of the present invention, a synchronization reference sequence (SRS) design is defined, which enables both synchronization and channel estimation utilizing the same reference symbols. That is, according to embodiments of the present invention, for defining such multipurpose synchronization reference sequence, the respective reference symbol is designed in such a manner that it is well suited for synchronization and for channel estimation. It is to be noted that an SRS may be the same or different among a set of cells, such that it may also be represented by a cell specific synchronization reference sequence (CSRS).

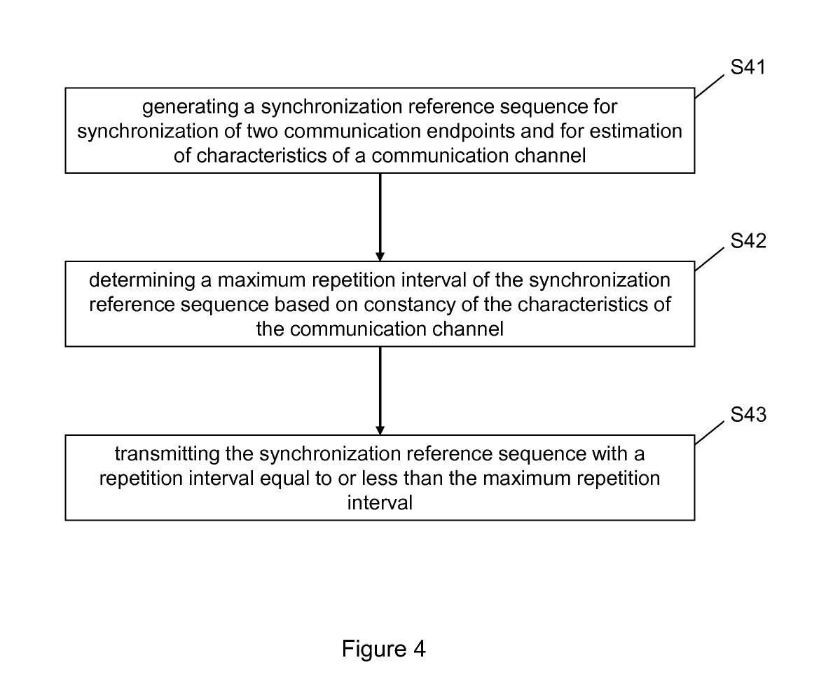

FIG. 4 is a schematic diagram illustrating a procedure according to embodiments of the present invention.

As shown in FIG. 4, a procedure according to embodiments of the present invention comprises an operation S41 of generating a synchronization reference sequence for synchronization of two communication endpoints and for estimation of characteristics of a communication channel, an operation S42 of determining a maximum repetition interval of the synchronization reference sequence based on constancy of the characteristics of the communication channel, and an operation S43 of transmitting the synchronization reference sequence with a repetition interval equal to or less than the maximum repetition interval.

According to a variation of the procedure shown in FIG. 4, example additional operations are given, which are inherently independent from each other as such. According to such variation, an example method according to embodiments of the present invention may comprise an operation of setting a communication frame duration less than or equal to the maximum repetition interval.

In other words, a reference symbol is designed with the multipurpose synchronization reference sequence in such a manner that it is well suited for synchronization and for channel estimation. This concept is then combined with system design, in which the frame duration is set based on the channel coherence time (repetition interval of SRS). This enables transmittal of SRS only at the beginning of each frame with no other training overhead being necessary over the common downlink portion of a frame.

The design requires balancing between several contradicting performance requirements. The proposed solution is considered mainly in view of multicarrier transmission scenarios. However, the proposal is not limited only to multicarrier transmission, but can equally be used in single carrier transmission with suitable signal processing.

It is to be noted that the synchronization reference sequence is suitable for supporting rules and requirements provided by higher layers. For example, the required length of the synchronization reference signal may be determined based on desired cell coverage.

According to a variation of the procedure shown in FIG. 4, example details of the generating operation are given, which are inherently independent from each other as such.

Such example generating operation according to embodiments of the present invention may comprise an operation of forming the synchronization reference sequence based on a Zadoff-Chu sequence, and an operation of embedding the synchronization reference sequence into an orthogonal frequency domain multiplexing symbol.

That is, according to embodiments of the present invention, the SRS is set inside one OFDM symbol in such a manner that it also contains good time domain correlation properties. One way to achieve this is, according to embodiments of the present invention, to start with a sequence with good time domain correlation properties and peak-to-average power ratio (PAPR) properties, like Zadoff-Chu sequences. Then, depending on an expected coherence bandwidth and a desired sequence length, the Zadoff-Chu sequence is repeated in the time domain in order to obtain desired frequency granularity for the frequency domain reference symbols whilst maintaining the designed time domain synchronization accuracy. As implied above, the synchronization reference sequence is not necessarily formed based on a Zadoff-Chu sequence, but may alternatively be based on any other sequence performing equally well or better than a Zadoff-Chu sequence in relation to the above mentioned properties.

The design of the combined sequence is a tradeoff between desired time domain correlation accuracy and desired code space size, and maximizing reference symbol distances in the frequency domain taking a coherence bandwidth limitation into consideration.

The SRS design according to embodiments of the present invention also improves the existence of several cells in the same band through the good code properties of Zadoff-Chu sequences. This design allows good synchronization and channel estimation properties even with severe overlap, for example in the cell edge. The SRS and/or URS may or may not be overlapping between different cells.

According to further embodiments of the present invention, the synchronization reference sequence is embedded together with payload into the orthogonal frequency domain multiplexing symbol.

That is, data transmission is enabled in the same OFDM symbol in which the SRS is transmitted without significant reduction in the synchronization performance. This allows a reduction of the overhead as the system bandwidth increases.

Furthermore, other cells following the proposed concept can also transmit their own SRS in the same time-frequency resources without significant reduction in the system performance. The SRS design can be provided with frequency reuse factor 1. Further, cell specific shifts in frequency domain can be applied to incorporate frequency reuse factors greater than 1 for SRS design. In addition, with the penalty of reduced throughput, cell specific discontinuous transmission (DTX) modes can be defined to reduce the interference between neighboring cells.

According to embodiments, two design alternatives for utilization in synchronized local area communications are provided.

Namely, according to embodiments of the present invention, the orthogonal frequency domain multiplexing symbol extends over a predetermined communication frequency band, and the synchronization reference sequence is contiguously embedded into the orthogonal frequency domain multiplexing symbol corresponding to a partial frequency band of the predetermined communication frequency band.

That is, the first design alternative is based on a narrow band control region. By narrow band it is meant that the control region, in which SRS and system control information are transmitted, uses only a fraction of the total system bandwidth. This design alternative allows spectral reuse for control bands, whilst the data portion is provided with spectral reuse 1 over the system bandwidth. This design alternative further allows devices not capable of signal processing or reception over the full system bandwidth to detect the SRS and synchronize and perform accurate channel estimation over the control bandwidth.

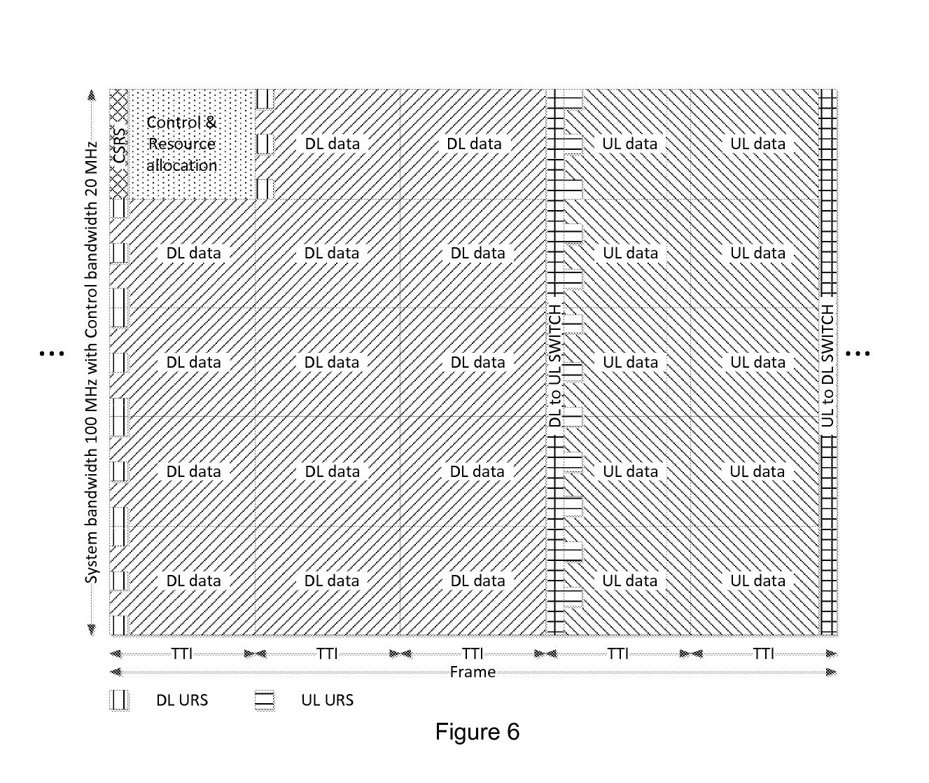

FIG. 6 is a schematic diagram illustrating example distribution of a synchronization reference sequence in frequency and time domain according to embodiments of the present invention, namely according to this concentrated SRS design. In FIG. 6 a frame structure for a TDD based system is shown. However the present invention is also applicable to a frequency division duplex (FDD) system. As shown in FIG. 6, the SRS (cross-hatched) is located in an example 20 MHz bandwidth of an example 100 MHz bandwidth. The SRS fully utilizes the subcarriers located in the control bandwidth (i.e. the control region), but all the other carriers in the respective OFDM symbol are free for data or user specific reference symbols (URS, horizontally or vertically hatched). In this design, URS are required for users (mobile stations) operating in the full (system) bandwidth, because SRS is transmitted only on the control region. The used URS follow the same principle and are transmitted only at the beginning of the frame for DL and at the beginning of the first UL TTI in the UL portion.

Further, according to embodiments of the present invention, the orthogonal frequency domain multiplexing symbol extends over a predetermined communication frequency band, and the synchronization reference sequence is, with respect to the predetermined communication frequency band, discontiguously distributed embedded into the orthogonal frequency domain multiplexing symbol. That is, the second design alternative provides SRS distributed over full system bandwidth.

Note that the term “discontiguously distributed embedded” should be taken to mean that the sequence is embedded into the symbol, while it is discontiguously distributed therein (or ‘embedded in a discontiguously distributed manner’).

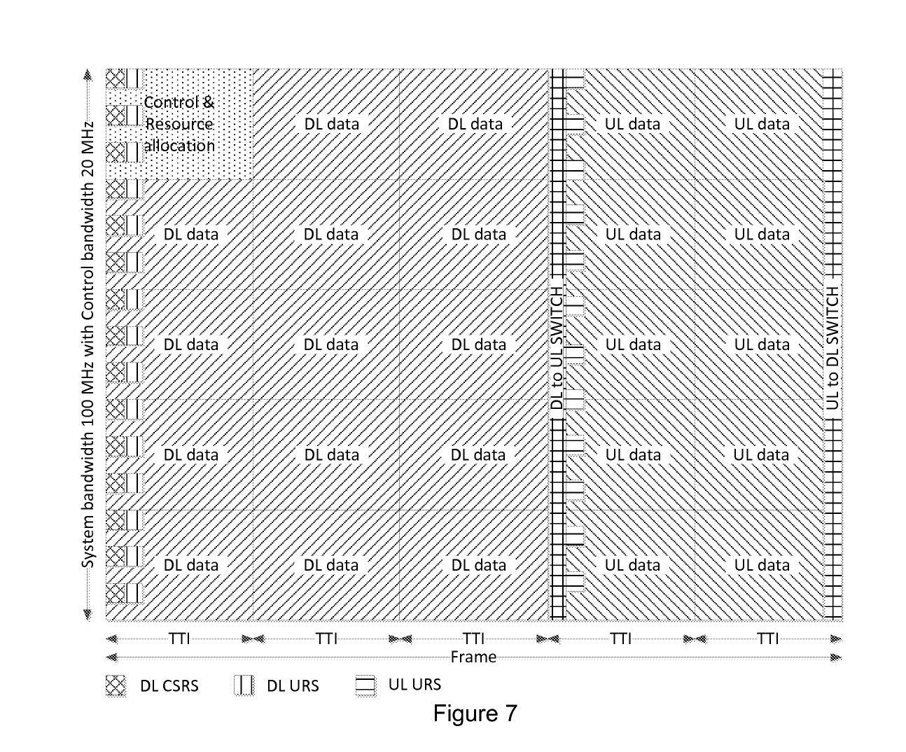

FIG. 7 is a schematic diagram illustrating example distribution of synchronization reference sequences in frequency and time domain according to embodiments of the present invention, namely according to this distributed SRS design.

According to this second design alternative, it is assumed that all devices (mobile stations) operating in the system bandwidth are also capable of listening to and processing the full bandwidth. By transmitting the SRS (cross-hatched) in a distributed manner, each mobile device can detect the desired cell and synchronize with the desired cell and obtain an accurate channel estimate over the full system bandwidth. For users with MIMO capabilities, with channel beamforming, etc., additional DL/UL URS (horizontally or vertically hatched) are required.

This distributed SRS enables the same benefits as the first design alternative. In addition, each user (mobile station) also gets in the synchronization process an accurate channel estimate over the full system bandwidth. Further, in distributed design, different operation modes may be enabled, in which the base station can decide how many SRS symbols are transmitted at the beginning of each frame. In this way, an adaption to environment (defining SRS length based on the channel delay spread) is possible. Further, intentionally causing cell breathing by either decreasing or increasing the SRS length is possible. In addition, for increased code diversity, the Zadoff-Chu code length may be changed. Various further measurements for enabling different operation modes may be implemented.

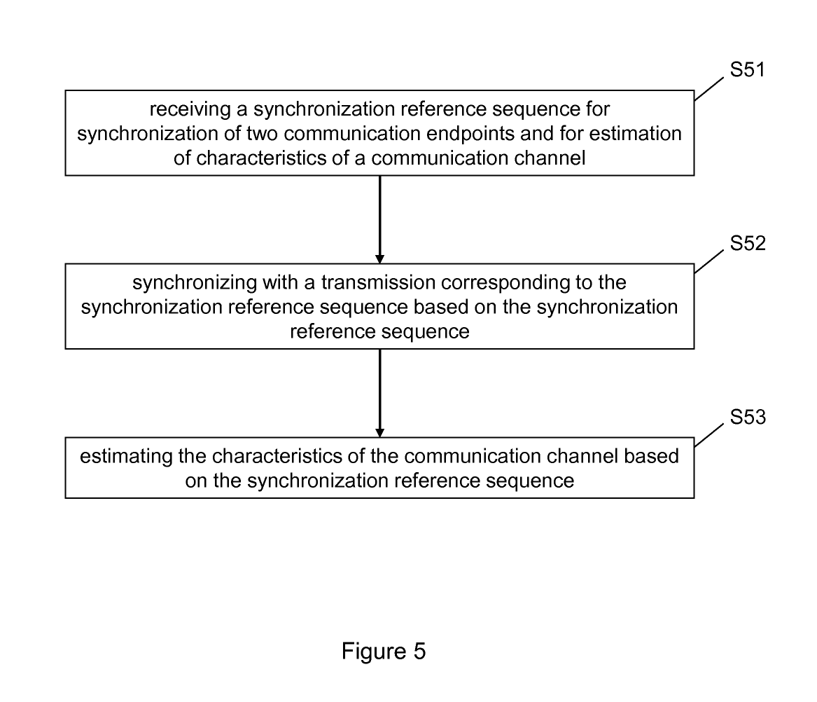

FIG. 5 is a schematic diagram illustrating a procedure according to embodiments of the present invention.

As shown in FIG. 5, a procedure according to embodiments of the present invention comprises an operation S51 of receiving a synchronization reference sequence for synchronization of two communication endpoints and for estimation of characteristics of a communication channel, an operation S52 of synchronizing with a transmission corresponding to the synchronization reference sequence based on the synchronization reference sequence, and an operation S53 of estimating the characteristics of the communication channel based on the synchronization reference sequence.

It is noted that techniques described in the prior art section do not combine RS with synchronization. According to embodiments of the present invention, a combined SRS is transmitted with the required periodicity, which allows mobile devices to synchronize and estimate channel, with very low latency, creating energy saving potential for the whole local area communications.

According to further embodiments of the present invention, the synchronization reference sequence is based on a Zadoff-Chu sequence, the synchronization reference sequence is embedded in an orthogonal frequency domain multiplexing symbol, and example details of the receiving operation are given, which are inherently independent from each other as such.

Such an example receiving operation according to embodiments of the present invention may comprise an operation of extracting the synchronization reference sequence from the orthogonal frequency domain multiplexing symbol.

According to further embodiments of the present invention, the synchronization reference sequence is embedded together with payload in the orthogonal frequency domain multiplexing symbol.

According to further embodiments of the present invention, the orthogonal frequency domain multiplexing symbol extends over a predetermined communication frequency band, the synchronization reference sequence is contiguously embedded in the orthogonal frequency domain multiplexing symbol corresponding to a partial frequency band of the predetermined communication frequency band, and the characteristics of the communication channel are estimated for the partial frequency band.

That is, according to embodiments of the present invention, devices not capable of signal processing or reception over full system bandwidth are enabled to detect the SRS and synchronize and perform accurate channel estimation over the control bandwidth, i.e. the partial frequency band.

According to further embodiments of the present invention, the orthogonal frequency domain multiplexing symbol extends over a predetermined communication frequency band, the synchronization reference sequence is, with respect to the predetermined communication frequency band, discontiguously distributed embedded in the orthogonal frequency domain multiplexing symbol, and the characteristics of the communication channel are estimated for the predetermined communication frequency band.

That is, by transmitting the SRS in a distributed manner, each mobile device can detect and synchronize to the desired cell and obtain an accurate channel estimate over the full system bandwidth. Hence, this distributed design of SRS allows the same benefits as the first design, but in addition each user also gets in the synchronization process an accurate channel estimate over the full system bandwidth.

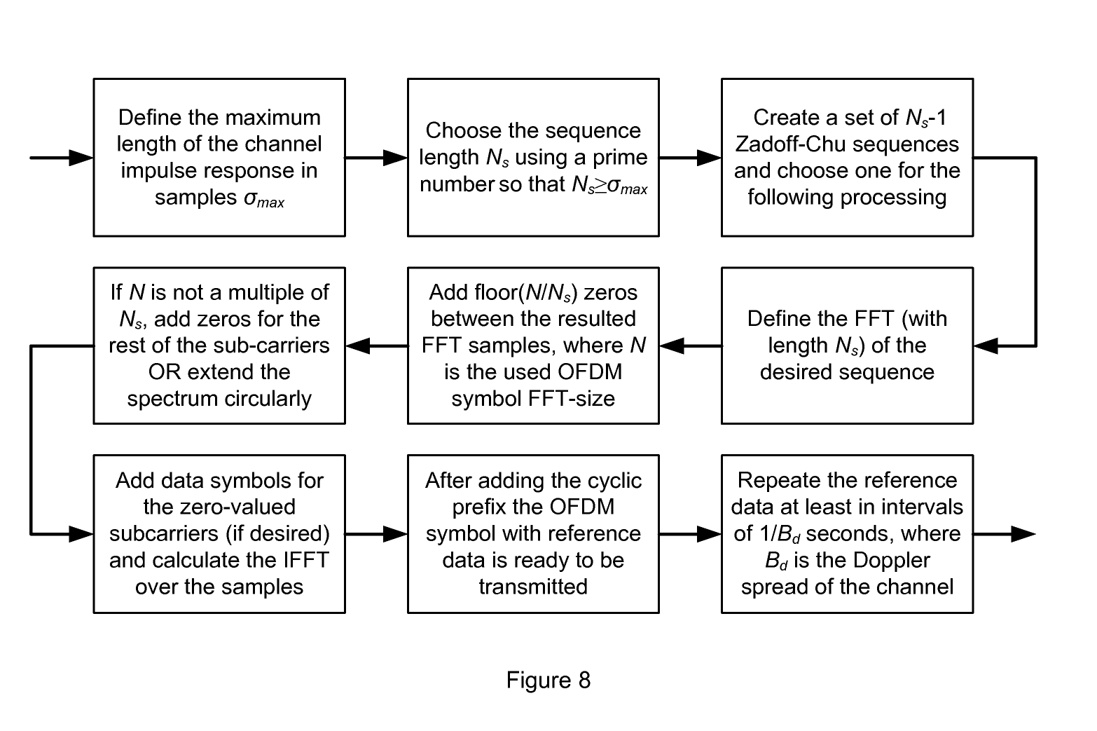

FIG. 8 is a schematic diagram illustrating a procedure to use frequency spread synchronization reference symbols in OFDM transmission according to embodiments of the present invention.

Namely, FIG. 8 illustrates an example design flow for designing a synchronized system with OFDM modulation based on embodiments of the present invention.

As is derivable from FIG. 8, a maximum length of a channel impulse response is defined in samples. Here, characteristics of a channel are considered. Further, a sequence length is chosen based on the channel impulse response. A set of Zadoff-Chu sequences is generated. In particular, a number of Zadoff-Chu sequences is determined (sequence length—1), and the determined number of Zadoff-Chu sequences is generated. In the following, one Zadoff-Chu sequence is selected from the generated set. A fast Fourier Transform (FFT) with the sequence length of the chosen Zadoff-Chu sequence is defined. A certain number of zeros is filled between the FFT samples, and/or the spectrum is extended circularly. Data symbols are added for subcarriers that are zero-valued based on the above mentioned zero-filling, if data embedding into the OFDM symbol that carries the SRS is desired. An inverse fast Fourier Transform (IFFT) is calculated over the resulting samples. For completion of the OFDM symbol with reference data, the cyclic prefix (CP) is to be added. As a result, the OFDM symbol is ready for transmission. The reference data is proposed to be repeated in intervals of the coherence time of the channel, i.e. the maximum frame duration in which it is possible to transmit only SRS at the beginning of the frame. The coherence time of the channel may be determined by means of the Doppler spread of the channel. The repetition interval may be longer if other means are used to adapt channel estimates and track frequency and time synchronization.

As discussed above, according to embodiments of the present invention only one or a fraction of one OFDM symbol is used for a synchronization reference symbol. Furthermore, no additional pilot tones are inserted among data subcarriers, because according to embodiments of the present invention, receivers (e.g. mobile stations) are able to follow the frequency variations (for example carrier frequency offset or phase noise) simply by using the CP appended at the beginning of each OFDM symbol or other available algorithms. At a more general level, modern iterative receivers are capable of utilizing the information of the received signal more efficiently and no additional pilot tones are required according to embodiments of the present invention because tracking the received signal can be achieved with multiple other means inside a modern receiver structure.

By taking into consideration local area propagation models and synchronized system with very short OFDM symbol, TTI, and frame duration, embodiments of the present invention provide significant RS overhead savings.

A main difference (among others) between WiMAX design and embodiments of the present invention is that in WiMAX the whole first OFDM symbol is dedicated for preamble. To the contrary, according to embodiments of the present invention, decreasing the preamble overhead is possible as the system bandwidth is increased. Depending on the cell range requirements, channel conditions and synchronization accuracy, minimum bandwidth for the SRS can be defined. If the system bandwidth equals this minimum bandwidth, the usage of the first OFDM symbol is comparable to the WiMAX preamble. However, embodiments of the present invention do at least not need to implement traditional RS symbols multiplexed with data transmission. In addition, the code design chosen in WiMAX is based on pseudorandom binary sequences which have higher correlation with the data modulation than with the Zadoff-Chu sequences according to embodiments of the present invention.

Embodiments of the present invention provide significantly lower average synchronization time compared to the above background art design proposals, even though the actual synchronization probability per single detection is smaller.

Further, significantly shorter common SRS are enabled, and no additional pilot tones (similar to RS in LTE) among the DL control/data transmission are needed in transmission of single spatial stream inside DL portion of the frame. If multiple spatial streams are to be transmitted in a certain frame, then additional URS needs to be inserted in the frame to support MIMO channel estimation. If desired, SRS and control field may or may not be part of a multi-antenna transmission with or without dedicated precoding.

In addition, significant overhead reduction in local area communications are provided with respect to known techniques and significant reduction of the average synchronization time (delay) are achieved for associated users after long sleep periods and even for new users if the experienced signal to interference plus noise ratio (SINR) is moderate.

Further, the present invention allows users to simultaneously detect and measure received correlation power per SRS from multiple access points or base stations, thus enabling efficient interference avoidance functions, localization with respect to other access points or base stations, and simplified cell change procedures initiated by the mobile device.

It is to be noted that only low-mobility and relatively wideband channel response scenarios are considered above, in which cases the invented design is a highly beneficial solution. However, higher mobility and narrower band channel response scenarios are not excluded, although the benefit might be reduced.

Additionally the above mentioned methods are applicable also to so-called Device to Device (D2D, Prose, Proximity Services) communication where two devices (mobile terminals, WLAN STAs etc.) communicate with each other directly. In this case, the methods can be applied in a way that both devices utilize DL or UL SRS in their respective frame transmissions (e.g. in contention based access) where the synchronization (between communication end points) is made at the beginning of each transmission. These methods may also be applied to transmission of so-called discovery signals between devices. Alternatively or additionally these methods could be used in cluster communication (or group communication) where one of the devices in the group is a so-called cluster head and may have more access point-like features and acts like a “master device” for the devices in the group.

Generally, the above-described procedures and functions may be implemented by respective functional elements, processors, or the like, as described below.

While the foregoing embodiments of the present invention are described mainly with reference to methods, procedures and functions, corresponding embodiments of the present invention also cover respective apparatuses, network nodes and systems, including both software, algorithms, and/or hardware thereof.

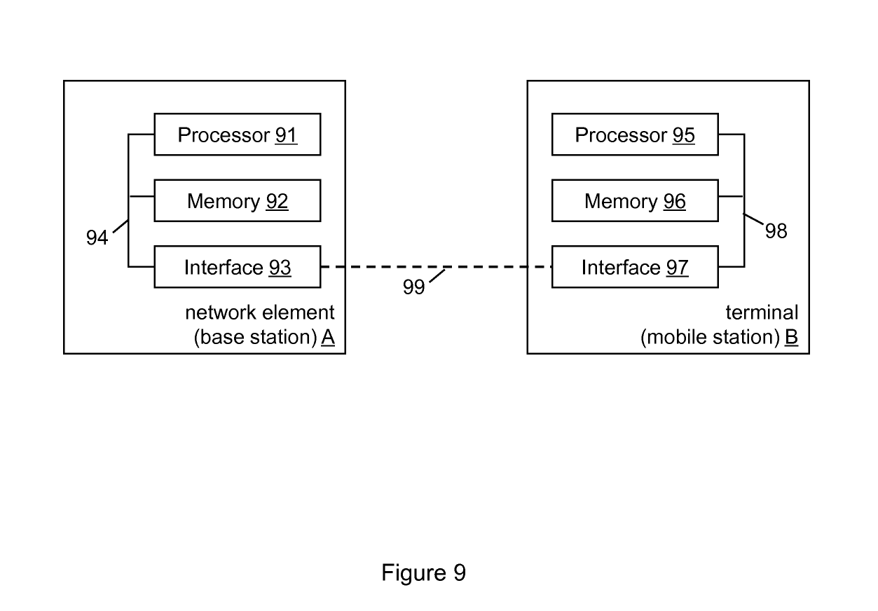

Respective embodiments of the present invention are described below referring to FIG. 9, while for the sake of brevity reference is made to the detailed description with regard to FIGS. 4 to 8.

In FIG. 9 below, which is noted to represent a simplified block diagram, the solid line blocks are configured to perform respective operations as described above. The entirety of solid line blocks are configured to perform the methods and operations as described above, respectively. With respect to FIG. 9, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of an arrow is meant to illustrate the direction in which certain operations are performed and/or the direction in which certain data is transferred.

Further, in FIG. 9, only those functional blocks are illustrated which relate to any one of the above-described methods, procedures and functions. A skilled person will acknowledge the presence of any other conventional functional blocks required for an operation of respective structural arrangements, such as e.g. a power supply, a central processing unit, respective memories or the like. Amongst others, memories are provided for storing programs or program instructions for controlling the individual functional entities to operate as described herein.

FIG. 9 shows a schematic block diagram illustrating example apparatuses according to embodiments of the present invention.

In view of the above, the thus described apparatuses A and B are suitable for use in practicing the embodiments of the present invention, as described herein.

The thus described apparatus A may represent a (part of a) network entity, such as a base station or access node or any network-based controller, and may be configured to perform a procedure and/or functionality as described in conjunction with any of FIGS. 4 and 6 to 8. Further, the thus described apparatus B may represent a (part of a) device or terminal such as a mobile station or user equipment or a modem (which may be installed as part of a mobile station or user equipment, but may be also a separate module, which can be attached to various devices), and may be configured to perform a procedure and/or functionality as described in conjunction with any of FIGS. 5 to 7.

As indicated in FIG. 9, according to embodiments of the present invention, the apparatus A comprises a processing system and/or processor 91, a memory 92 and an interface 93, which are connected by a bus 94 or the like. Further, according to embodiments of the present invention, the apparatus B comprises a processing system and/or processor 95, a memory 96 and an interface 97, which are connected by a bus 98 or the like, and the apparatuses may be connected via link 99, respectively.

The processor 91/95 and/or the interface 93/97 may also include a modem or the like to facilitate communication over a (hardwire or wireless) link, respectively. The interface 93/97 may include a suitable transceiver coupled to one or more antennas or communication means for (hardwire or wireless) communications with the linked or connected device(s), respectively. The interface 93/97 is generally configured to communicate with at least one other apparatus, i.e. the interface thereof.

The memory 92/96 may store respective programs assumed to include program instructions or computer program code that, when executed by the respective processor, enables the respective electronic device or apparatus to operate in accordance with the embodiments of the present invention.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the current description it is stated that the processing system and/or processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to embodiments of the present invention, an apparatus representing the base station A comprises at least one processor 91, at least one memory 92 including computer program code, and at least one interface 93 configured for communication with at least another apparatus. The processor (i.e. the at least one processor 91, with the at least one memory 92 and the computer program code) is configured to perform generating a synchronization reference sequence for synchronization of two communication endpoints and for estimation of characteristics of a communication channel, to perform determining a maximum repetition interval of the synchronization reference sequence based on constancy of the characteristics of the communication channel, and to perform transmitting the synchronization reference sequence with a repetition interval equal to or less than the maximum repetition interval.

In its most basic form, stated in other words, the apparatus A may thus comprise respective means for generating, means for determining and means for transmitting.

As outlined above, the apparatus B may comprise one or more of respective means for setting, means for forming, and means for embedding.

According to embodiments of the present invention, an apparatus representing the mobile station B comprises at least one processor 95, at least one memory 96 including computer program code, and at least one interface 97 configured for communication with at least another apparatus. The processor (i.e. the at least one processor 95, with the at least one memory 96 and the computer program code) is configured to perform receiving a synchronization reference sequence for synchronization of two communication endpoints and for estimation of characteristics of a communication channel, to perform synchronizing with a transmission corresponding to the synchronization reference sequence based on the synchronization reference sequence, and to perform estimating the characteristics of the communication channel based on the synchronization reference sequence.

In its most basic form, stated in other words, the apparatus B may thus comprise respective means for receiving, means for synchronizing and means for estimating.

As outlined above, the apparatus B may comprise one or more of respective means for extracting.

For further details regarding the operability/functionality of the individual apparatuses, reference is made to the above description in connection with any one of FIGS. 4 to 8, respectively.

According to embodiments of the present invention, a system may comprise any conceivable combination of the thus depicted devices/apparatuses and other network elements, which are configured to cooperate with any one of them.

For the purpose of the present invention as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the ideas of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus such as the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the ideas of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for synchronization and channel estimation in local area communication scenarios. Such measures may for example comprise generating a synchronization reference sequence for synchronization of two communication endpoints and for estimation of characteristics of a communication channel, determining a maximum repetition interval of the synchronization reference sequence based on constancy of the characteristics of the communication channel, and transmitting the synchronization reference sequence with a repetition interval equal to or less than the maximum repetition interval.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

### LIST OF ACRONYMS AND ABBREVIATIONS

3GPP 3^{rd} Generation Partnership Project
AGC automatic gain control
CP cyclic prefix
CRS cell specific reference symbol
CSRS cell specific synchronization reference sequence/symbol
D2D device to device
DL downlink
DTX discontinuous transmission
FDD frequency division duplex
FFT fast Fourier Transform
IFFT inverse fast Fourier Transform
L-SIG legacy signal
LTE Long Term Evolution
MCS modulation and coding scheme
MIMO multiple input multiple output
OFDM orthogonal frequency domain multiplexing
PAPR peak-to-average power ratio
PLCP physical layer convergence protocol
PPDU PLCP protocol data unit
PSS primary synchronization sequence
RS reference symbol
SINR signal to interference plus noise ratio
SRS synchronization reference sequence/symbol
SSS secondary synchronization sequence
TDD time division duplex
TTI transmit time interval
UE user equipment
UL uplink
URS user specific reference symbol
VHT very high throughput
VHT-SIG VHT signal
WiMAX Worldwide Interoperability for Microwave Access
WLAN wireless local area network

1. A method for use in synchronization and channel estimation, the method comprising:
generating a synchronization reference sequence for synchronization of two communication endpoints and for estimation of characteristics of a communication channel;
determining a maximum repetition interval of said synchronization reference sequence based on constancy of said characteristics of said communication channel; and
transmitting said synchronization reference sequence with a repetition interval equal to or less than said maximum repetition interval.

2. A method according to claim 1, further comprising setting a communication frame duration less than or equal to said maximum repetition interval.

3. A method according to claim 1, wherein said synchronization reference sequence is suitable for supporting rules and requirements provided by higher layers.

4. A method according to claim 1, wherein, in relation to said generating, said method further comprises:
forming said synchronization reference sequence based on a Zadoff-Chu sequence; and
embedding said synchronization reference sequence into an orthogonal frequency domain multiplexing symbol.

5. A method according to claim 4, wherein said synchronization reference sequence is embedded together with payload into said orthogonal frequency domain multiplexing symbol.

6. A method according to claim 4, wherein:
said orthogonal frequency domain multiplexing symbol extends over a predetermined communication frequency band, and
said synchronization reference sequence is contiguously embedded into said orthogonal frequency domain multiplexing symbol corresponding to a partial frequency band of said predetermined communication frequency band.

7. A method according to claim 4, wherein:
said orthogonal frequency domain multiplexing symbol extends over a predetermined communication frequency band, and
said synchronization reference sequence is, with respect to said predetermined communication frequency band, discontiguously distributed embedded into said orthogonal frequency domain multiplexing symbol.

8. A method for use in synchronization and channel estimation, the method comprising:
receiving a synchronization reference sequence for synchronization of two communication endpoints and for estimation of characteristics of a communication channel;
synchronizing with a transmission corresponding to said synchronization reference sequence based on said synchronization reference sequence; and
estimating said characteristics of said communication channel based on said synchronization reference sequence.

9. A method according to claim 8, wherein said synchronization reference sequence is suitable for supporting rules and requirements provided by higher layers.

10. A method according to claim 8, wherein:
said synchronization reference sequence is based on a Zadoff-Chu sequence,
said synchronization reference sequence is embedded in an orthogonal frequency domain multiplexing symbol, and
in relation to said receiving, said method further comprises extracting said synchronization reference sequence from said orthogonal frequency domain multiplexing symbol.

11. A method according to claim 10, wherein said synchronization reference sequence is embedded together with payload in said orthogonal frequency domain multiplexing symbol.

12. A method according to claim 10, wherein:
said orthogonal frequency domain multiplexing symbol extends over a predetermined communication frequency band,
said synchronization reference sequence is contiguously embedded in said orthogonal frequency domain multiplexing symbol corresponding to a partial frequency band of said predetermined communication frequency band, and
said characteristics of said communication channel are estimated for said partial frequency band.

13. A method according to claim 10, wherein:
said orthogonal frequency domain multiplexing symbol extends over a predetermined communication frequency band,
said synchronization reference sequence is, with respect to said predetermined communication frequency band, discontiguously distributed embedded in said orthogonal frequency domain multiplexing symbol, and
said characteristics of said communication channel are estimated for said predetermined communication frequency band.

14. An apparatus for use in synchronization and channel estimation on a network side of a wireless system, the apparatus comprising a processing system including at least one processor and a memory storing computer program code, in which the processing system is arranged to cause the apparatus to:
generate a synchronization reference sequence for synchronization of two communication endpoints and for estimation of characteristics of a communication channel;
determine a maximum repetition interval of said synchronization reference sequence based on constancy of said characteristics of said communication channel; and
transmit said synchronization reference sequence with a repetition interval equal to or less than said maximum repetition interval.

15. The apparatus according to claim 14, wherein the processing system is arranged to cause the apparatus to set a communication frame duration less than or equal to said maximum repetition interval.

16. The apparatus according to claim 14, wherein said synchronization reference sequence is suitable for supporting rules and requirements provided by higher layers.

17. The apparatus according to claim 14, wherein the processing system is arranged to cause the apparatus to:
form said synchronization reference sequence based on a Zadoff-Chu sequence; and
embed said synchronization reference sequence into an orthogonal frequency domain multiplexing symbol.

18. The apparatus according to claim 17, wherein said synchronization reference sequence is embedded together with payload into said orthogonal frequency domain multiplexing symbol.

19. The apparatus according to claim 17, wherein:
said orthogonal frequency domain multiplexing symbol extends over a predetermined communication frequency band, and
said synchronization reference sequence is contiguously embedded into said orthogonal frequency domain multiplexing symbol corresponding to a partial frequency band of said predetermined communication frequency band.

20. The apparatus according to claim 17, wherein:
said orthogonal frequency domain multiplexing symbol extends over a predetermined communication frequency band, and
said synchronization reference sequence is, with respect to said predetermined communication frequency band, discontiguously distributed embedded into said orthogonal frequency domain multiplexing symbol.
